(19) United States
(12) Patent Application Publication
(10) Pub. No.: US 2015/0098616 A1
(43) Pub. Date: Apr. 9, 2015

(54) OBJECT RECOGNITION AND MAP GENERATION WITH ENVIRONMENT REFERENCES

(71) Applicant: QUALCOMM Incorporated, San Diego, CA (US)

(72) Inventors: Michael Gervautz, Vienna (AT); Romain Tallonneau, Vienna (AT); Qi Pan, Wien (AT)

(21) Appl. No.: 14/505,431

(22) Filed: Oct. 2, 2014

Related U.S. Application Data
(60) Provisional application No. 61/886,597, filed on Oct. 3, 2013.
(60) Provisional application No. 61/886,599, filed on Oct. 3, 2013.
(60) Provisional application No. 61/887,281, filed on Oct. 4, 2013.
(60) Provisional application No. 62/051,866, filed on Sep. 17, 2014.

(51) Int. Cl. G06K 9/00; G06K 9/62; G06T 7/00; G06K 9/46

(52) U.S. Cl. CPC G06K 9/00624; G06K 9/4604; G06K 9/6202; G06T 7/004; G06T 2207/30244
USPC 382/103

(57) ABSTRACT

Exemplary methods, apparatuses, and systems for performing object detection on a mobile device are disclosed. A reference dataset comprising a set of reference keyframes for an object captured in a plurality of different lighting environments is obtained. An image of the object in a current lighting environment is captured. Reference keyframes are grouped into respective subsets according to one or more of: a reference keyframe camera position and orientation (pose), a reference keyframe lighting environment, or a combination thereof. Feature points of the image are compared with feature points of the reference keyframes in each of the respective subsets. A candidate subset of reference keyframes from the respective subsets is selected in response to the comparing feature points. A reference keyframe from the candidate subset of reference keyframes is selected for triangulation with the image of the object.

### CROSS-REFERENCE TO RELATED APPLICATIONS

This application claims the benefit of U.S. Provisional Application No. 61/886,599, filed on Oct. 3, 2013, U.S. Provisional 61/886,597, filed Oct. 3, 2013, U.S. Provisional Application No. 61/887,281, filed Oct. 4, 2013, and U.S. Provisional Application No. 62/051,866, filed Sep. 17, 2014.

### FIELD

The present disclosure relates generally to detecting and tracking objects.

### BACKGROUND

Simultaneous localization and mapping (SLAM) may be used in augmented reality systems and robot navigation to build a map from an environment or scene. SLAM uses camera sensor data or images as input to build the map of the environment and the map can include one or more objects that can be used as a target for detection and tracking.

For SLAM to track or determine camera position and orientation (pose) the system may refer to a predetermined reference model, map, or set of reference keyframes. For example, a known or previously acquired reference can be a 3D model or map of a target. In some cases, the environment at the time of capture of the reference may be significantly different than the environment present at time of a user initiated redetection of the reference. Differences in tracking within an object environment may be influenced by intensity of light, angle/direction of light, background color/busyness, etc. For example, certain lighting environments may be so different from a reference environment, that a redetection system cannot discover and track the target object. Without an accurate reference, objects can appear at the wrong location, or mapping of the environment may fail altogether.

Mobile devices (e.g., smartphones) may be used to create and track a three-dimensional map of an object. However, mobile devices may have limited storage and processing, particularly in comparison to powerful fixed installation server systems. Therefore, the capabilities of mobile devices to accurately and independently determine a feature rich and detailed map of an object may be limited. Therefore, efficient low overhead techniques to detect and track targets in a variety of environmental situations is beneficial.

### SUMMARY

Embodiments disclosed herein may relate to a method to create a three-dimensional reference map of an object. The method may include receiving a plurality of input images of an object, each input image capturing the object in one of a plurality of different lighting environments. The method may also include tagging each of the plurality of input images with a lighting tag representing the respective lighting environment during the image capture. The method may further include creating, from the plurality of input images with lighting tags, the three-dimensional reference map of the object.

Embodiments disclosed herein may also relate to a machine readable non-transitory storage medium with instructions to create a three-dimensional reference map of an object. The medium may include instructions to receive a plurality of input images of an object, each input image capturing the object in one of a plurality of different lighting environments. The medium may also include instructions to tag each of the plurality of input images with a lighting tag representing the respective lighting environment during the image capture. The medium may further include instructions to create, from the plurality of input images with lighting tags, the three-dimensional reference map of the object.

Embodiments disclosed herein may relate to a data processing device including a processor and a storage device configurable to store instructions to create a three-dimensional reference map of an object. The device may include instructions to receive a plurality of input images of an object, each input image capturing the object in one of a plurality of different lighting environments. The device may also include instructions to tag each of the plurality of input images with a lighting tag representing the respective lighting environment during the image capture. The device may further include instructions to create, from the plurality of input images with lighting tags, the three-dimensional reference map of the object.

Embodiments disclosed herein may relate to an apparatus for creating a three-dimensional reference map of an object. The apparatus may include means for receiving a plurality of input images of an object, each input image capturing the object in one of a plurality of different lighting environments. The apparatus may also include means for tagging each of the plurality of input images with a lighting tag representing the respective lighting environment during the image capture. The apparatus may further include means for creating, from the plurality of input images with lighting tags, the three-dimensional reference map of the object.

Embodiments disclosed herein may relate to a method for performing object detection with a mobile device. The method may include obtaining a reference dataset comprising a set of reference keyframes for an object captured in a plurality of different lighting environments and capturing an image of the object in a current lighting environment. The method may also include grouping reference keyframes together into respective subsets according to one or more of: a reference keyframe camera position and orientation (pose), a reference keyframe lighting environment, or a combination thereof. The method may further include comparing feature points of the image with feature points of the reference keyframes in each of the respective subsets and selecting a candidate subset from the respective subsets, in response to the comparing feature points. Additionally, the method may also include selecting, for triangulation with the image of the object, a reference keyframe from the candidate subset.

Embodiments disclosed herein may also relate to a machine readable non-transitory storage medium with instructions to perform object detection with a mobile device. The medium includes instructions for obtaining a reference dataset comprising a set of reference keyframes for an object captured in a plurality of different lighting environments and capturing an image of the object in a current lighting environment. The medium may also include instructions for grouping reference keyframes together into respective subsets according to one or more of: a reference keyframe camera position and orientation (pose), a reference keyframe lighting environment, or a combination thereof. The medium may also include instructions for comparing feature points of the image with feature points of the reference keyframes in each of the respective subsets and selecting a candidate subset from the respective subsets, in response to the comparing feature points. Additionally, the medium may also include instructions for selecting, for triangulation with the image of the object, a reference keyframe from the candidate subset.

Embodiments disclosed herein may relate to an apparatus for performing object detection. The apparatus may include means for obtaining a reference dataset comprising a set of reference keyframes for an object captured in a plurality of different lighting environments and capturing an image of the object in a current lighting environment. The apparatus may also include means for grouping reference keyframes together into respective subsets according to one or more of: a reference keyframe camera position and orientation (pose), a reference keyframe lighting environment, or a combination thereof. The apparatus may also include means for comparing feature points of the image with feature points of the reference keyframes in each of the respective subsets and selecting a candidate subset from the respective subsets, in response to the comparing feature points. Additionally, the apparatus may also include means for selecting, for triangulation with the image of the object, a reference keyframe from the candidate subset.

Embodiments disclosed herein may relate to a mobile device including a processor and a storage device configurable to store instructions to perform object detection. The device may include instructions for obtaining a reference dataset comprising a set of reference keyframes for an object captured in a plurality of different lighting environments and capturing an image of the object in a current lighting environment. The device may include instructions for grouping reference keyframes together into respective subsets according to one or more of: a reference keyframe camera position and orientation (pose), a reference keyframe lighting environment, or a combination thereof. The device may include instructions for comparing feature points of the image with feature points of the reference keyframes in each of the respective subsets and selecting a candidate subset from the respective subsets, in response to the comparing feature points. Additionally, the device may include instructions for selecting, for triangulation with the image of the object, a reference keyframe from the candidate subset.

Other features and advantages will be apparent from the accompanying drawings and from the detailed description.

### BRIEF DESCRIPTION OF THE DRAWINGS

FIG. 1A is a block diagram of an environment for performing SLAM and Enhanced Object Detection, in one embodiment;

FIGS. 1B-1E illustrate the effects of the example lighting environments illustrated in FIG. 1A, in one embodiment;

FIG. 2A is a flow diagram illustrating a method for creating a 3D reference map of an object, in one embodiment;

FIG. 2B is a flow diagram illustrating a method for filtering reference keyframes from a dataset according to lighting intensity values, in one embodiment;

FIG. 3 is a flow diagram illustrating a method for performing Enhanced Object Detection, in one embodiment;

FIGS. 4 and 5 illustrate an exemplary hemisphere grid representation of pose grouping by region;

FIG. 6 illustrates an exemplary histogram determination for a target object;

FIG. 7 illustrates an exemplary lighting environment and lighting intensity tag organization for a reference dataset; and

FIG. 8 is a block diagram illustrating an exemplary system in which described embodiments may be practiced.

### DETAILED DESCRIPTION

Typical object detection and tracking systems may fail or produce errors when a current lighting and background environment for detecting objects is different than the lighting and background environment in which a reference dataset (e.g., reference map, universal map, or reference database) was created. In one embodiment, a reference dataset is created with objects captured in a variety of lighting and background environments/conditions. In one embodiment, an Enhanced Object Detection (EOD) system leverages the created reference dataset to markedly improve real world object detection and tracking.

Object detection and tracking systems may search a reference dataset to find a matching keyframe having the same features as a captured image. A matching keyframe is used to determine the current camera position and orientation (pose) by triangulating the matching keyframe to the captured image. Triangulating keyframes to a captured image may be a processor intensive process involving geometric alignment of matching features from multiple keyframes to determine camera pose. Therefore, techniques to reduce the number of keyframes for attempted triangulation can improve processing time and efficiency. In one embodiment, a subset of reference keyframes from the reference database most likely to result in a successful triangulation (match) is selected. In one embodiment, triangulation is performed with one or more keyframes from the subset of keyframes instead of the entire reference database in order to reduce the number of keyframes to triangulate, which is beneficial in mobile device or processor limited implementations.

In one embodiment, a subset of all available reference keyframes is selected for detection and tracking by tagging or classifying reference keyframes with a lighting environment property (e.g., a tag, description, or classification). A mobile device can attempt to measure the current lighting environment (e.g., from an ambient light sensor, or histogram of a captured image) and match the determined current lighting environment to the lighting environment property in the reference dataset. For example, the light sensor may record the overall lighting in a captured image relatively bright (e.g., according to a threshold or baseline). The mobile device may attempt to isolate a subset of keyframes in the reference dataset with bright environment conditions For example, the mobile device may ignore or exclude reference keyframes associated with dark or low light reference setup conditions. In response to determining a first subset of reference keyframes, the mobile device can perform a count of the number of matches between features of the current input image to the features from each of the keyframes in the subset of reference keyframes. The lighting type (e.g., tag) having the most feature matches is selected as the lighting type to use for all tracking (e.g., a second subset) in the current environment.

In one embodiment, a subset of the reference keyframes is selected for tracking by separating reference keyframes into regions according to the reference keyframe's respective camera pose. To determine which region (e.g., area including reference keyframes) to use for triangulation, features of the captured image are matched to reference keyframes in the reference dataset. Each reference keyframe having a feature matching a feature of the captured image triggers a “vote” for an associated camera pose of the reference keyframe containing the match. In one embodiment, the region receiving the most votes is used as the subset of reference keyframes for triangulation with the captured image.

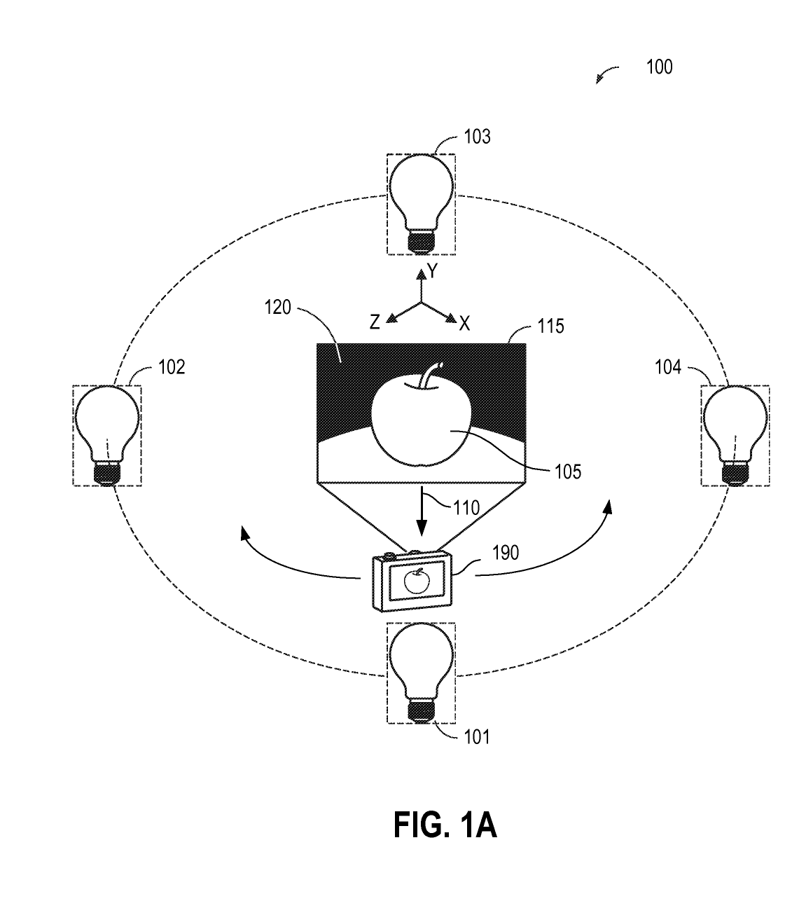

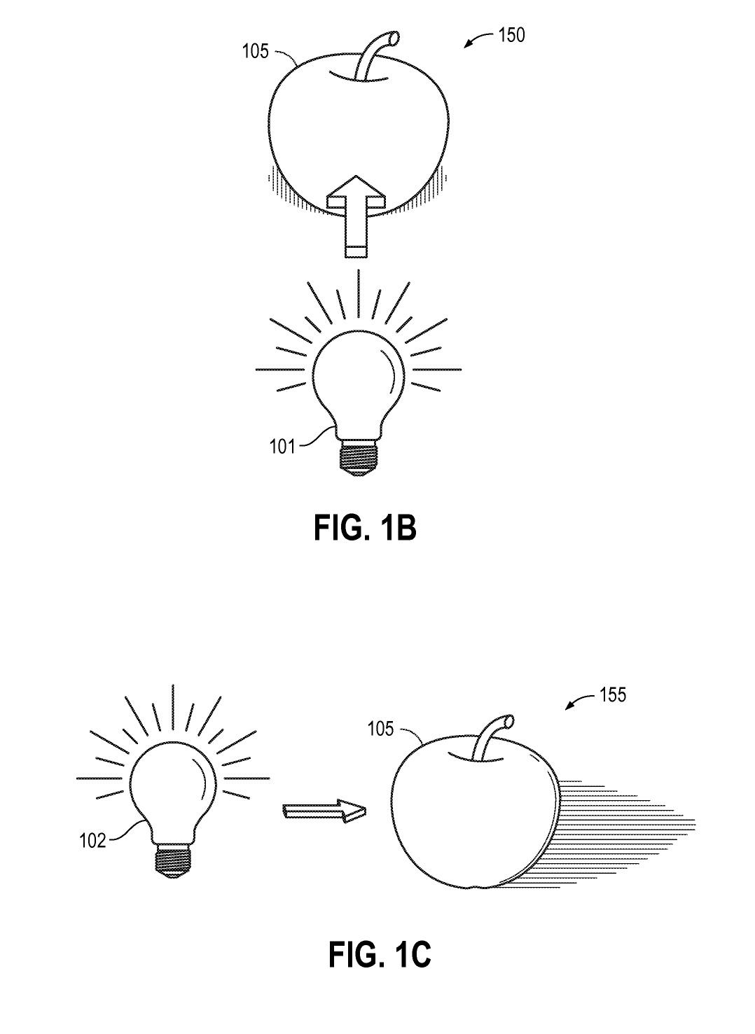

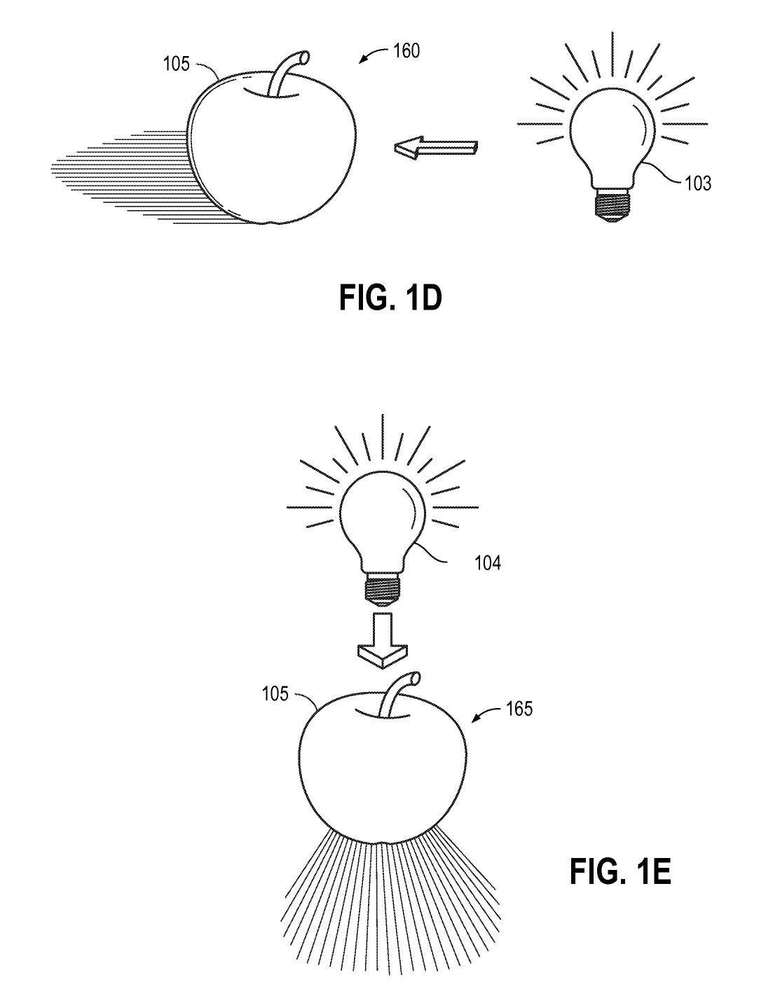

FIG. 1A is a block diagram of an environment for performing SLAM and Enhanced Object Detection, in one embodiment. Environment 100 may be a setup/reference environment used to create a reference dataset. For example, device 190 may traverse environment 100 having a number of different lighting and background setups to build a diverse reference dataset. FIG. 1A also illustrates an example environment for a device to perform SLAM or EOD to detect and track object 105 (e.g., a three dimensional real-world object). For example, device 190 may perform real-time detection or tracking of object 105 in an unknown environment using a reference dataset generated at a prior point in time.

A reference dataset can include one or more of: keyframes, triangulated features points, and associations between keyframes and feature points. A keyframe can consist of an input image (e.g., an image captured by device 190) and camera parameters (e.g., pose of the camera in a coordinate system) used to produce the image.

A feature (e.g., feature point) as used herein is as an interesting or notable part of an image. The feature points from an image may represent distinct points along three-dimensional space (e.g., coordinates on axes X, Y, and Z) and every feature point may have an associated feature location. Each feature point may represent a 3D location, and be associated with a surface normal and one or more descriptors. Pose detection can then involve matching one or more aspects of one keyframe with another keyframe. Feature points (e.g., within an input image or captured image) may be extracted (e.g., by device 190 from an input or reference image) using a well-known technique, such as Scale Invariant Feature Transform (SIFT), which localizes feature points and generates their descriptors. Alternatively, other techniques, such as Speed Up Robust Features (SURF), Gradient Location-Orientation histogram (GLOH), or a comparable technique may be used.

In one embodiment, a reference dataset includes multiple different or unique lighting and background environments (e.g., context, setups, etc.) used by SLAM or EOD for matching objects within a captured image. When saving reference images or keyframes for feature matching, an environment/map may be documented (e.g., recorded, or otherwise saved to a file, dataset, etc.) under different conditions (e.g., different light directions, intensity, position, and/or different backgrounds). In one embodiment, as few as two well-selected unique environment setups (e.g., light source position, light source intensity, light source direction, background configuration, etc.) provides sufficient reference coverage for a broad range of possible object detection and tracking conditions. In other embodiments, many different unique environment setups may be included within a reference dataset.

The reference dataset generation technique described herein can use a camera tracking method (e.g., a SLAM system) that determines the pose of the camera capturing the object at any time. The SLAM system may generate a sequence of keyframes covering a plurality of viewing angles. In one embodiment, while tracking and populating the reference dataset, a SLAM system can include different “sets” of light conditions and backgrounds. For example, a first set may include multiple poses to capture a target object with a front light situation and black background, while a second set may include a backlit situation with a white background. An unlimited number of combinations of light positions, intensities, and backgrounds are possible. The resulting reference dataset created from the different environment conditions enhances object detection and tracking from any angle and in any future environment condition.

Environment 100 illustrates a SLAM system (or other system to create a reference dataset) with a variety of environments in which one or more objects will be detected and tracked. For example, the reference dataset may include representations of objects captured within a dark room as well as with bright and direct lighting. Objects may also be captured against different backgrounds (e.g., an empty white walled room or inside a dark library with bookshelves).

In the illustrative example of FIG. 1A, object 105 is setup for various lighting environments and background configurations. FIG. 1A may be captured as data in a reference dataset by a SLAM system. For example, environment 100 may be a controlled studio environment. Environment 100 may also be an environment similar or the same as the environment where device 190 performs (e.g., runtime) object detection and tracking. For example, when implemented in a client device, a setup/reference environment may be an actual customer/client environment, or simulated customer/client environment. In this illustrative example, a lighting source (e.g., natural light, flash, incandescent, florescent bulb, or other light type) is positioned around object 105. For example, the lighting source placed in ninety degree increments (e.g., along path 150 around object 105) can be in front of object 105 (e.g., light 101), to a first side of object 105 (e.g., light 102), to the rear or behind object 105 (e.g., light 103), or to a second side of object 105 (e.g., light 104 on the opposite side of the target from light 102). At the various lighting locations, device 190 can capture input images and create keyframes for storage into the reference dataset. Arrow 110 illustrates the reflective light bouncing from the target back into the capture device (e.g., device 190). In other embodiments, other lighting setups with more or less lighting sources, directions, or intensities may be utilized to populate the reference dataset. In this illustrated example image 115, background 120 is white, however different backgrounds may be cycled in (e.g., captured within a lighting set) while also changing the lighting setup. Alternatively, the backgrounds may be changed while the lighting stays constant (e.g., one direction and intensity).

In one embodiment, a variety of different or unique lighting environments (e.g., as illustrated in FIG. 1A and other lighting arrangements not specifically illustrated) are saved (e.g., tagged, associated, etc.) with reference keyframes as lighting properties (e.g., tags, characterizations, descriptors etc.). For example, reference keyframes may be grouped together (e.g., organized through the use of common tags or properties) to create a unique, light dependent representation of the target object. A SLAM system or other map creation process can build a 3D map representation of objects and scenes with the reference keyframes having the variety of different of unique lighting environments.

EOD can leverage the reference dataset (e.g., 3D map of the environment), including the various representations of the target object, at runtime to detect and track the object by focusing triangulation and tracking to particular lighting environments or properties. In one embodiment, the reference dataset includes keyframes that are tagged or indexed according to their respective (e.g., particular) lighting environment at time of capture. For example, a front light situation (e.g., “light setup X” or other description) may be tagged into a keyframe such that the set of keyframes with the front light situation may be easily found (e.g., by searching or organizing according to “light setup X”). In some embodiments, lighting environment may be described in natural language terms (e.g., florescent light at camera left 90 degrees, power set to 0.5), with number codes (e.g., a serial number, or as “light setup X”, etc.) or other representation for EOD to match reference keyframes with a current estimated lighting environment.

Although some embodiments described herein refer to environment properties (e.g., lighting or background tags, indexes, characteristics, etc.) as included within a reference dataset, this is optional. Objects within unknown environments may also be detected and tracked without environment property references. In other words, in response to tracking an captured image to a reference keyframe, the specific setup details of the reference environment does not affect whether a feature match occurs or whether the matching reference keyframe is within a particular pose region.

During map generation (e.g., performed by a SLAM system), as the device 190 moves around and captures images or video, the device can receive additional image frames for updating the reference dataset. For example, additional feature points and keyframes may be captured and incorporated into the reference dataset on the device 190. In one embodiment, the device can match 2D features extracted from a camera image to the 3D features contained in a reference dataset (e.g., a set of predetermined reference keyframes). From the 2D-3D correspondences of matched features, the device can determine the camera pose. In one embodiment, device 190 can receive a captured image and extract features (e.g., 3D map points associated with a scene) and can estimate a 6DOF camera position and orientation from a set of feature point correspondences. In one embodiment, EOD and/or the SLAM system captures the light intensity (e.g., using sensors and/or histogram data) during the map generation. In one embodiment, light environment data and background data may be included within in each keyframe.

FIGS. 1B-1E illustrate the effects of the example lighting environments illustrated in FIG. 1A, in one embodiment. FIG. 1B illustrates a front light source 101 and resulting captured image 110 of a target object (e.g., apple 105). FIG. 1C illustrates a camera left side light source 102 and resulting captured image 115 of a target object 105. FIG. 1D illustrates a camera right side light source 104 and resulting captured image 120 of a target object 105. FIG. 1E illustrates a light source 104 behind the target and behind the camera, resulting in the captured image 125 of a target object

In one embodiment, Enhanced Object Detection (EOD) (e.g., implemented as a method, engine, module, etc.) accesses the reference dataset containing a variety of lighting and background setups (e.g., predetermined reference keyframes) and matches features of an input image to the reference dataset. In one embodiment, EOD (e.g., initiated or performed by a user on a mobile device) can detect (e.g., identify, or recognize from a database or reference) a target object in a camera image captured at the device. In response to detecting the object, an augmented reality (AR) system can provide additional digital content and information associated to that object (e.g., an augmented reality overlay or additional contextual information). EOD may be separate and distinctly implemented from SLAM (e.g., in separate modules, engines, devices, etc.), or in some embodiments may be integrated so that EOD has features of SLAM or SLAM has features of EOD. For example, when the object is detected in captured image, information in a webpage browser or other user interface may be displayed (e.g., to provide graphical representation of detection and/or tracking) without interfacing with a SLAM system. In other embodiments, object detection can trigger a SLAM system that provides augmentation of virtual objects on top and around the detected physical object or target.

EOD can receive an input camera image partially or fully containing the object (e.g., captured image) in an unknown environment. EOD can access reference keyframes of the object captured within the reference dataset. In one embodiment, EOD can separate each reference keyframe into distinct groups according to each keyframe's respective camera position and orientation (pose). EOD can select a keyframe (e.g., from the reference keyframes) for triangulation with the received keyframe. In one embodiment, the selected keyframe is selected from the distinct group having the most feature points matching the input (e.g., captured) image. The selected keyframe may also come from the distinct group having the most number of reference keyframes with at least one feature point match to the input image.

In some embodiments, a lighting intensity threshold determines whether a reference keyframe is included during object detection and tracking. For example, reference keyframes may be removed from consideration when the intensity threshold shows that a histogram or intensity is mostly black pixels, or mostly white pixels (e.g., extreme ends of the spectrum in a histogram). Specific numerical intensity thresholds or ranges of thresholds may be configured in some embodiments.

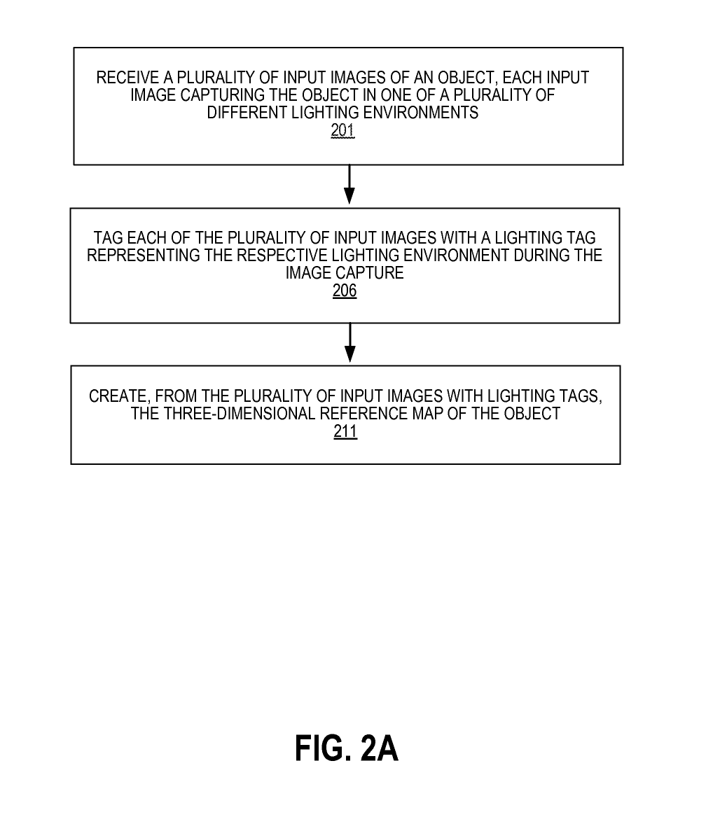

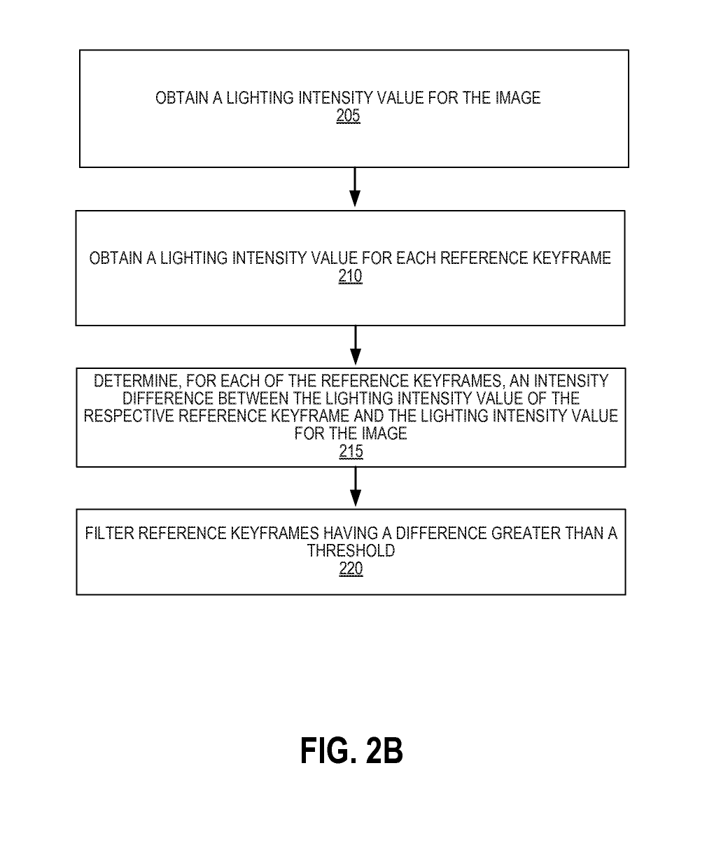

FIG. 2A is a flow diagram illustrating a method for creating a 3D reference map of an object, in one embodiment. At block 201, the embodiment (e.g., implemented as software or hardware of mobile device 190) receives a plurality of input images of an object, each input image capturing the object in one of a plurality of different lighting environments. For example, the different lighting may include a variety of a lighting source positions, a lighting intensities, background configurations, or any combination thereof.

At block 206, the embodiment tags each of the plurality of input images with a lighting tag representing the respective lighting environment during the image capture. For example, as introduced above, lighting environments may be tagged with natural language terms (e.g., incandescent light above object, intensity of 100 lumens), with a codes representation (e.g., a serial number, or as “light setup Y”, etc.).

At block 211, the embodiment creates, from the plurality of input images with lighting tags, the 3D reference map of the object. The 3D reference map may is also described herein as a reference dataset which may include a set of reference keyframes and camera pose data.

FIG. 2B is a flow diagram illustrating a method for filtering reference keyframes from a dataset according to light intensity values, in one embodiment. EOD can determine a light intensity associated with the input keyframe and select a subset of the reference dataset (e.g., subset of keyframes) compatible with the determined light intensity. EOD can compare image feature points of the captured image with reference feature points of the first subset of the reference keyframes to find a set of potential feature point matches. In response to finding a set of potential feature point matches, EOD can select the lighting intensity tag with the most occurrences within the first set of potential feature point matches, where each feature point in the set of potential feature point matches has an associated lighting environment tag occurrence. EOD (e.g., with SLAM) can also detect and track the target using a second subset of the reference keyframes, where the second subset includes reference images associated with a lighting environment tag. The lighting environment may include references to particular lighting configurations of the reference dataset. For example, a hard light at camera right may be tagged with an associated description in the reference dataset. In one embodiment the second subset is a subset of the first subset. By narrowing the potential reference keyframes to triangulate (first with light intensity tag, then again by feature matching popularity of lighting environment tag) mobile devices (or low processing power devices) can utilize larger reference datasets while still providing real-time tracking and mapping.

At block 205, the embodiment (e.g., implemented as software or hardware of mobile device 190) obtains a lighting intensity value for the image. A scene or environment captured by a camera may have an overall intensity (e.g., dark, or bright), where the lighting intensity value may be determined from one or more of a light sensor reading obtained concurrently with the capture of the image, a histogram for the image, or any combination thereof. For example, an ambient light sensor reading at the time of image capture is associated with the camera input frame (or camera input image). In some embodiments, in addition to or instead of the ambient light sensor reading, a histogram of the input image is determined.

At block 210, embodiment obtains a lighting intensity value for each of the reference keyframes. The lighting intensity values for keyframes may be determined at the time each respective keyframe was captured as an image. For example, as described above, concurrently with image camera, a value from a light sensor may be associated with the reference keyframe. Light intensity values for keyframes may also be determined according to histogram data as also described above.

At block 215, the embodiment determines, for each of the reference keyframes, an intensity difference between the light intensity value of the respective reference keyframe and the light intensity value for the image. For example, the embodiment can determine a scene is approximately as dark as the environment of a particular subset of reference keyframes. In some embodiments, the difference threshold is configurable. For example, if the reference dataset has many different lighting environments with many shades of intensity the threshold may be less than a reference dataset that just has a bright and a dark lighting environment.

At block 220, the embodiment filters reference keyframes having a difference greater than a threshold. For example, reference keyframes with a bright lighting environment may not be relevant to detection and tracking of a current dark environment. In one embodiment, a light sensor can determine the current conditions so that EOD can discard database features that do not match the lighting conditions. In another embodiment, an image (e.g., the input camera image, or captured image) is analyzed by processing a histogram of intensity in order to detect a best match lighting situation from the reference dataset. For example, if the ambient light sensor and/or histogram show a very bright scene, a similarly bright scene within a reference dataset would be compatible. Alternatively if the scene overall is very dark, a darker scene in the reference dataset would be considered compatible. The embodiment can isolate all compatible reference keyframes and create a subset of just the compatible reference keyframes.

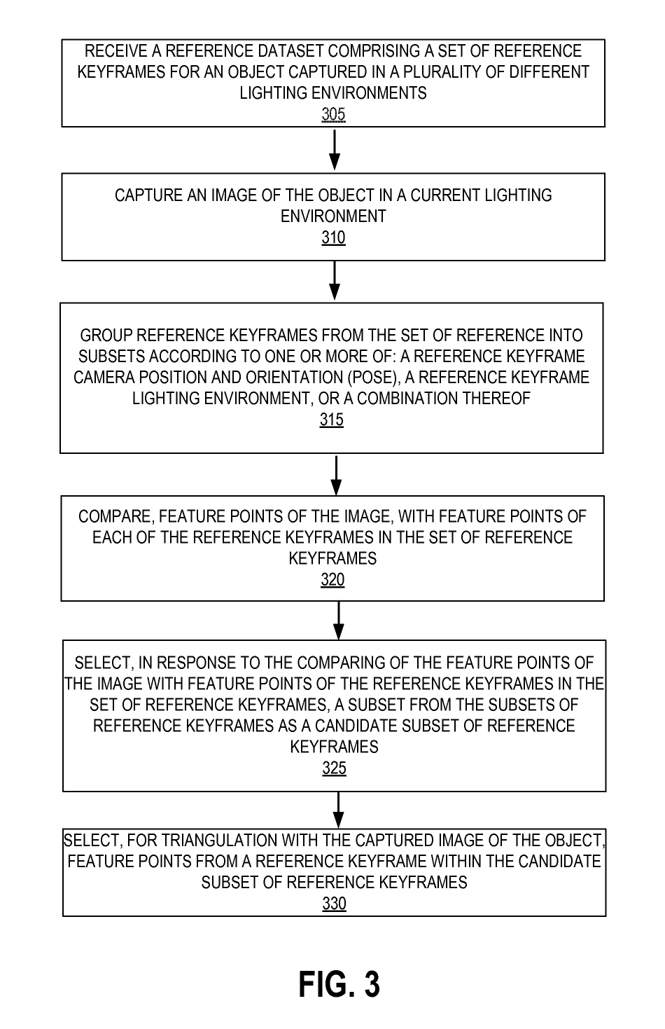

FIG. 3 is a flow diagram illustrating a method for performing Enhanced Object Detection, in one embodiment. At block 305, the embodiment (e.g., implemented as software or hardware of mobile device 190), obtains a reference dataset comprising a set of reference keyframes for an object captured in a plurality of different lighting environments. The reference dataset (e.g., reference dataset) may be located on a remote server, or within a keyframe dataset local to the device. Each reference keyframe can include a respective camera position and orientation (pose), and feature points associated with the respective camera pose. The reference keyframes may be captured with unique and varied lighting intensities and positions.

At block 310, the embodiment captures an image of the object in a current lighting environment. For example, the image may be an input image captured by the device's camera or may be a still video frame from a video feed. The embodiment can process incoming images for use in the system. For example, the embodiment can determine feature points within the input image.

At block 315, the embodiment groups reference keyframes from the set of reference keyframes into respective subsets of reference keyframes according to one or more of: a reference keyframe camera position and orientation (pose), a reference keyframe lighting environment, or a combination thereof. For example, each reference keyframe may be separated into one of a plurality of distinct groups according to each reference keyframe's pose. In one embodiment, every keyframe has an associated pose and reference keyframes are grouped together (or otherwise assigned/tagged) with the same or similar poses into a pose region. By grouping according to pose, feature point matches to reference keyframes having a pose in isolated regions separate from the rest of the matching reference keyframes may indicate an error or exception keyframe to be excluded from consideration for tracking and triangulation. Some features, for example features in a checkered pattern, may be similar enough to match an input keyframe regardless of the actual camera pose. However, once camera pose is considered, outliers in the potential matching reference keyframe selection can become apparent. Erroneous outlier reference keyframes may be excluded from triangulation, saving processing time, and producing more accurate (e.g., jitter free) tracking.

In one embodiment, EOD can also group reference keyframes according to each respective reference keyframe's particular lighting environment. Grouping, as used herein may be used to describe tagging or otherwise identifying two or more reference keyframes with a same or similar lighting environment property. Lighting environment may be as described throughout this description, such as, but not limited to including light quantity, light position, light intensity, and background.

At block 320, the embodiment compares, feature points of the image, with feature points of each of the reference keyframes in the set of reference keyframes. In one embodiment, the comparison with feature points includes determining whether at least one feature point from the image matches to a feature within the reference keyframes. For example, for each respective subset determined from block 315 (e.g., a subset with subset members having a same or similar pose), EOD can count the unique reference keyframes matching at least one feature point from the image. For example, out of “X” keyframes in a subset, EOD may determine “Y” reference keyframes contain a feature point that matches with the captured image (i.e., count of unique reference keyframe matches). The subset with the most number of keyframes containing a match (e.g., largest “Y” value) may be selected as a candidate subset of reference images below at block 325.

In another embodiment, the comparison with feature points includes determining the total count for all feature points in a subset that match features points from the captured image. For example, EOD can determine, for each respective subset, a total count of the feature points in the respective subset that match feature points from the image. In response to determining the total count of the feature points for each respective subset, EOD can assign the respective subset with the greatest total count of feature points matches as the candidate subset. For example, out of “X” number of keyframes in a subset, EOD may determine that there are “Y” number of feature point matches to the image.

In another embodiment, the comparison with feature points includes determining a reference keyframe with the most number of matches to the captured image and determining which lighting environment property is associated with that reference keyframe. For example, out of “X” number of keyframes in a subset, EOD may determine that a detected keyframe has “Y” number of matches, which is the most number of matches for a single keyframe. EOD can determine a lighting property of the detected keyframe with the “Y” number of matches. Reference keyframes may be tagged or otherwise associated with one or more lighting properties associated with the environment conditions at time of image capture. For example, a reference keyframe may be tagged or otherwise associated with a light position, intensity, or background.

In some embodiments, EOD may utilize a combination of one or more of the previously mentioned grouping/association techniques. EOD may leverage multiple groups or tags to create the respective subsets. For example, first grouping by lighting property and then further subdividing the lighting property groups according to pose, or other combinations.

At block 325, the embodiment selects a candidate subset from the respective subsets, in response to the comparing feature points. For example, the result of the comparison at block 320 may be a count of unique reference keyframes matching at least one feature point of the image. In response to counting the unique reference keyframes at block 320, EOD can assign the subset with the greatest count of unique reference keyframes matching at least one feature point of the image as the candidate subset.

In another embodiment, the result of the comparison at block 320 may be total count of the feature points in each subset that match feature points from the image. In response to determining the total count of the feature points for each respective subset, EOD can select the respective subset with the greatest total count of feature points matches as the candidate subset.

In another embodiment, the result of the comparison at block 320 may be a keyframe determined as having the most number of feature point matches to the image. In response to determining the reference keyframe with the most number of feature point matches comprises a particular lighting environment, EOD assigns the subset representing the particular lighting environment as the selected candidate subset. For example, in response to determining a majority of matches are associated with a particular lighting type, that particular lighting type is marked as the likely lighting for the target. In another example, the current lighting environment of the target may be heavy backlighting. The embodiment can determine that most of the feature matches of the camera input frame indicate matches with reference keyframes having heavy backlighting and select heavy backlighting as a tag to indicate the target environment. In response to determining the reference keyframe with the most number of feature point matches comprises a particular lighting environment, EOD assigns the subset representing the particular lighting environment as the candidate subset.

In some embodiments, a combination of the above described selection techniques is possible. For example, EOD can select a candidate subset according to lighting environment as well as total feature count, or other combinations.

At block 330, the embodiment selects, for triangulation with the image of the object, a reference keyframe from the candidate subset. The embodiment selects a matching keyframe from the candidate subset for triangulation. The matching keyframe may be selected from a pose group having the most collective matching feature points with the input image or a pose group with the most reference keyframes having at least one feature point match with the camera input frame (or input camera image). For example, the pose group may be a region defined by a geometric shape (e.g., a sphere or hemisphere as described in greater detail below). In some embodiments, the actual selected matching keyframe may be any of the keyframes within the region.

In one embodiment, EOD subdivides the geometric shape representation of the keyframes (e.g., a hemisphere or sphere) into equivalent sized areas (e.g., regions) and the subdivision may be dependent on the number of keyframes in the reference dataset. Each region may have a “vote” for pose. In some embodiments, features can be observed within angles of 45 degrees or more, therefore a pose region may be defined as an area comprising viewing angle for 45 degrees or more in all directions on the hemisphere. In other embodiments, subdividing regions into areas less than the 45 degrees can still provide for accurate pose determination.

Camera pose may be determined by the number of matching feature points between a reference keyframe and an input keyframe. Feature points are determined to be corresponding when they have similar descriptors. From all the matched feature points, a few that can be verified to geometrically fit together may be selected. From the 3D position of each feature point in the map, and the 2D position of the feature point of the input image, the pose of the camera that created the input image can be determined. In one embodiment matching 4 or more feature points may be sufficient to determine a six degree of freedom pose. The EOD can receive the 3d position of the feature points from the map and the 2D positions in the image, which can provide input constraints.

Many different types of environmental situations may be present when EOD is initiated (upon initial image capture for tracking). However, expanding the reference dataset to include a large amount of lighting and background models may be prohibitively expensive for the limited space and processing capabilities of mobile devices. In one embodiment, EOD can reduce the processing requirements of a large database by grouping or organizing reference keyframes into groups based on pose. In some embodiments, each reference keyframe's feature points may vote on a suggested pose in response to matching an input reference keyframe. By voting or grouping based on pose, EOD can reduce the number of reference frames that may be triangulated to the input reference keyframe, allowing for processing on mobile devices.

In one embodiment, pre-modeling or pre-populating a reference dataset with a carefully chosen sample set may effectively cover a majority of possible situations. For example, although a wide variety of lighting situations may be present, a reference dataset with a target object captured at ninety-degree increments of a light source is highly effective in producing a useful reference dataset.

In one embodiment, EOD tracks from the selected matching keyframe, where the matching keyframe is from the reference dataset that has a similar lighting environment, light direction, and viewing direction as the camera input frame. For example, if heavy backlighting lighting environment tag received the most feature point matches, EOD with SLAM may perform tracking of the target using reference keyframes having a heavy backlighting tag. To track the target, EOD may find correspondences (i.e., feature point locations in both an input image and a reference image) and calculate the 3D structure of these corresponding feature points along with the motion that moved the camera from the input image to the reference image.

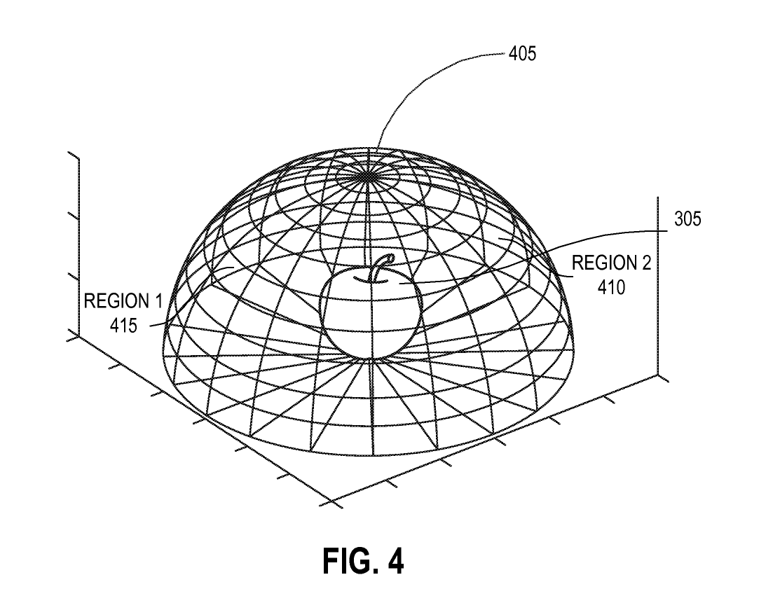

FIG. 4 illustrates a hemisphere grid representation of pose grouping by region, in one embodiment. As illustrated in FIG. 4, the target object (e.g., object 105) may be located at the relative center of the hemisphere (e.g., hemisphere 405) and all camera poses face the direction of the center of the hemisphere. As illustrated the camera pose may be any point or coordinate within the hemisphere. Although illustrated as unequal regions (e.g., region 1 415 and region 2 410), in some embodiments, each region covers an equal volume within the sphere or hemisphere. Alternatively, regions may be arranged such that each region includes a same or similar number of keyframes.

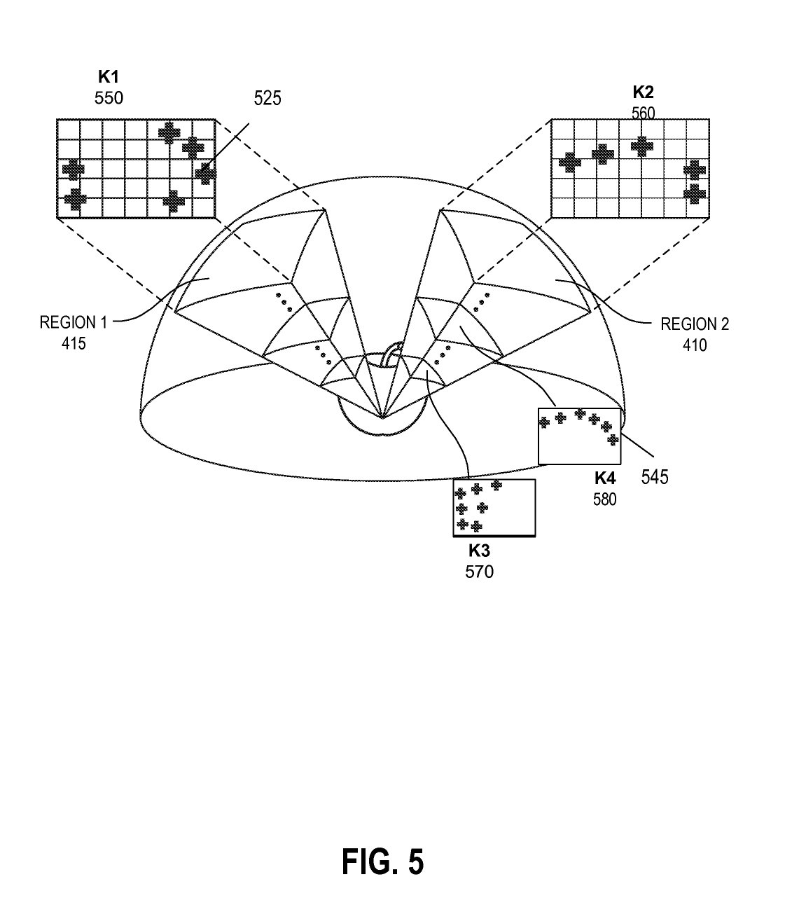

FIG. 5 illustrates an alternative view of a hemisphere grid representation of pose grouping by region, in one embodiment. As illustrated in FIG. 5, regions 1 and 2 (e.g., 415 and 410 respectively) may include all coordinates not just on the outer hemisphere of the sphere but also all coordinates within the area from the surface to the center of the hemisphere (e.g., camera pose moving closer or farther to the object or center). In one embodiment, during capture of reference keyframes (e.g., K1-K4) feature points (e.g., point 525) may be determined and used for future matching to an input keyframe taken within an unknown environment. As illustrated, each keyframe (e.g., K1 550, K2 560, K3 570, and K4 580) may include the capture image, feature points (e.g., 530, 535, 540, and 550 respectively), and an associated camera pose at time of image capture. For example, for each keyframe, the SLAM system can compute the 3-point pose. A 3-point pose can be determined by matching features in the keyframe image to the Map Database and finding three or more 2D-3D matches, which correspond to a consistent pose estimate.

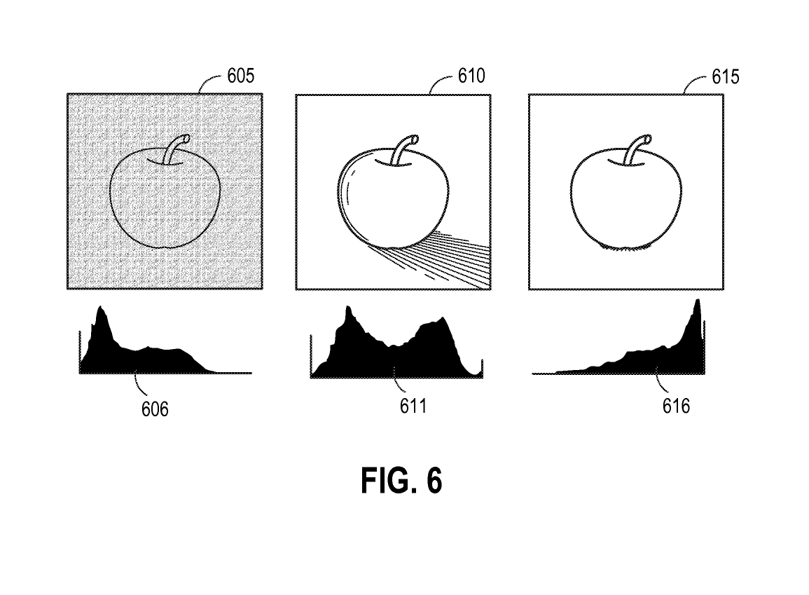

FIG. 6 illustrates a histogram output for a set of images, in one embodiment. By processing an image to create a histogram, image properties relating to lighting setup may be determined. As illustrated, a first image 605 with backlighting may produce an overly dark image. Histogram 606 shows that dark pixels dominate overall in the backlighting keyframe. The second image 610 shows a target object with neutral lighting, such that there is an even distribution of light and dark pixels within the histogram 611. The last image 615 shows a front lit situation with great light intensity such that the scene is brighter than the previous images. This may indicate the light source is greater than the other images, or the light source is closer to the target. The histogram 616 shows that pixels with bright values skew the histogram upward to the right (where light values are represented).

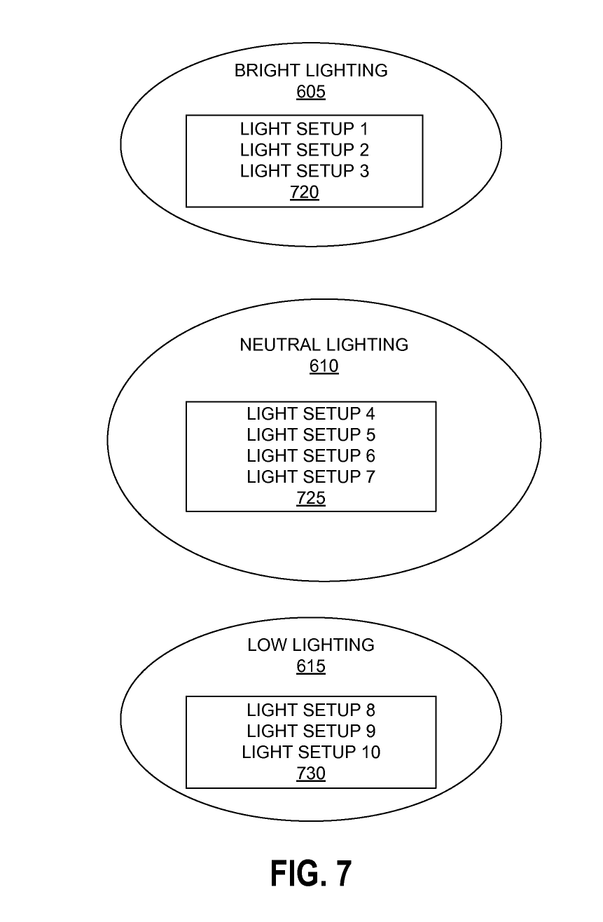

FIG. 7 illustrates an exemplary lighting environment and lighting intensity tag organization for a reference dataset. In one embodiment, the lighting configurations as described above with respect to FIGS. 1A-1D each have an associated lighting environment tag or property as descried above (e.g., Light Setup 1, Light Setup 2, etc.). Each light setup (e.g., environments, condition, configuration, etc.) 1-10 may have an associated lighting intensity (e.g., bright lighting 605 is associated with light environments 720, neutral lighting 610 is associated with light environments 720, low lighting 615 is associated with light environments 730) that describes the overall light of the scene as measured from a respective camera position. In some embodiments a mobile device determines (e.g., with an ambient light sensor, or image capture histogram result) a light intensity for a current scene and limits feature matching to compatible lighting intensity tags within the reference dataset.

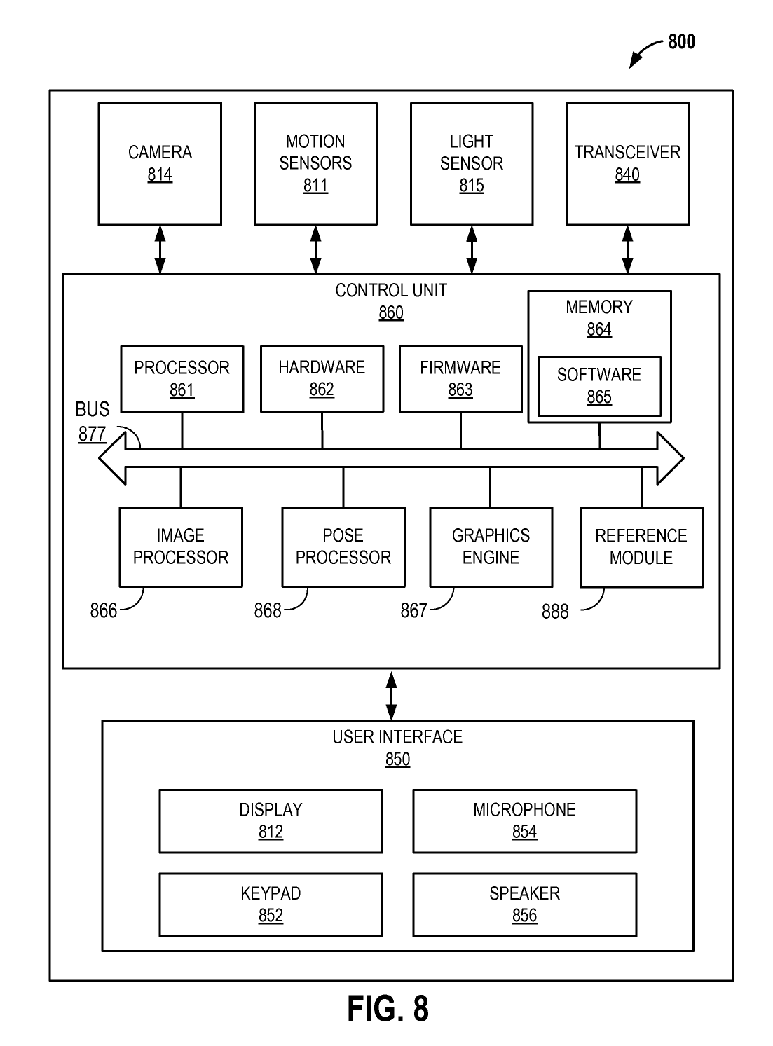

FIG. 8 is a block diagram illustrating an exemplary system in which described embodiments may be practiced. The system (e.g., the EOD and SLAM system) may be a device 190, which may include a control unit 860. The system may be a device 190, which may include a general purpose processor 861, SLAM module 866, object detection module 868, graphics engine 867, and a memory 864. The object detection module described herein may be a hardware or software implementation of EOD as described herein. The SLAM module described herein may be a hardware or software implementation of SLAM as described herein. The system may also include a reference dataset 888 to store and provide reference keyframes (e.g., the reference dataset or reference database). The device 190 may also include a number of device sensors coupled to one or more buses 877 or signal lines further coupled to at least one of the processors (e.g., 861, 866, and 868). Note that control unit 860 can be configured to implement methods of performing EOD and SLAM as described below. For example, the control unit 860 can be configured to implement functions of the mobile device 190 described in FIG. 2B above. In some embodiments, SLAM and EOD may be implemented on separate devices as well as integrated into the same device. For example, device 190 may be a non-portable or non-mobile device such as a desktop computer or server to implement SLAM and device 190 may be portable or mobile when integrated with EOD.

The device 190 may also include a number of device sensors coupled to one or more buses 877 or signal lines further coupled to at least one of the processors or modules. The device 190 may be a: mobile device, wireless device, cell phone, personal digital assistant, wearable device (e.g., eyeglasses, watch, head wear, or similar bodily attached device), robot, mobile computer, tablet, personal computer, laptop computer, or any type of device that has processing capabilities.

In one embodiment, the device 190 is a mobile/portable platform. The device 190 can include a means for measuring light source intensity, such as light sensor 815 (e.g., an ambient light sensor, etc.). The device 190 can include a means for capturing an image (e.g., an input image), such as camera 814 and may optionally include sensors 811 and light sensor 890 (e.g., an ambient light sensor) which may be used to provide data with which the device 190 can be used for determining position and orientation (i.e., pose) or light intensity. For example, sensors may include accelerometers, gyroscopes, quartz sensors, micro-electromechanical systems (MEMS) sensors used as linear accelerometers, electronic compass, magnetometers, or other motion sensing components. The device 190 may also capture images of the environment with a front or rear-facing camera (e.g., camera 814). The device 190 may further include a user interface 850 that includes a means for displaying an augmented reality image, such as the display 812. The user interface 850 may also include a keyboard, keypad 852, or other input device through which the user can input information into the device 190. If desired, integrating a virtual keypad into the display 812 with a touch screen/sensor may obviate the keyboard or keypad 852. The user interface 850 may also include a microphone 854 and speaker 856, e.g., if the device 190 is a mobile platform such as a cellular telephone. The device 190 may include other elements such as a satellite position system receiver, power device (e.g., a battery), as well as other components typically associated with portable and non-portable electronic devices.

The device 190 may function as a mobile or wireless device and may communicate via one or more wireless communication links through a wireless network that are based on or otherwise support any suitable wireless communication technology. For example, in some aspects, the device 190 may be a client or server, and may associate with a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with a server, other mobile devices, cell phones, other wired and wireless computers, Internet web-sites, etc.

As described above, the device 190 can be a portable data processing device (e.g., smart phone, wearable device (e.g., head mounted display, glasses, etc.), AR device, game device, or other device with AR processing and display capabilities). The device implementing the AR system described herein may be used in a variety of environments (e.g., shopping malls, streets, offices, homes or anywhere a user may use their device). Users can interface with multiple features of their device 190 in a wide variety of situations. In an AR context, a user may use their device to view a representation of the real world through the display of their device. A user may interact with their AR capable device by using their device's camera to receive real world images/video and process the images in a way that superimposes additional or alternate information onto the displayed real world images/video on the device. As a user views an AR implementation on their device, real world objects or scenes may be replaced or altered in real time on the device display. Virtual objects (e.g., text, images, video) may be inserted into the representation of a scene depicted on a device display.

The device 190 may in some embodiments, include an Augmented Reality (AR) system to display an overlay or object in addition to the real world scene. In one embodiment, EOD may identify objects in the camera image and may in some embodiments also start tracking, or initiate a separate tracker (e.g., a SLAM system). During the tracking of the object a user may interact with an AR capable device by using the device's camera. The camera can receive real world images/video and the device can superimpose or overlay additional or alternate information onto the displayed real world images/video projected onto the display. As a user views an AR implementation on their device, EOD can replace or alter in real time real world objects. EOD as described herein can insert virtual objects (e.g., text, images, video, or 3D object) into the representation of a scene depicted on a device display. For example, a customized virtual photo may be inserted on top of the target object. The SLAM system can provide an enhanced AR experience by using precise localization with the augmentations.

The word “exemplary” or “example” as used herein, means “serving as an example, instance, or illustration.” Any aspect or embodiment described herein as “exemplary” or as an “example” is not necessarily to be construed as preferred or advantageous over other aspects or embodiments.

The embodiments as described herein may be implemented as software, firmware, hardware, module or engine. In one embodiment, the features of the EOD system described herein (e.g., methods illustrated in at least FIG. 2A, FIG. 2B, and FIG. 3) may be implemented by the general purpose processor 861 in device 190 to achieve the previously desired functions. In some embodiments, instead of being directly integrated in a SLAM system, the embodiments described herein may be implemented as a separate module or engine that is distinct from a SLAM module or engine.

The methodologies and mobile device described herein can be implemented by various means depending upon the application. For example, these methodologies can be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes can be stored in a memory and executed by a processing unit. Memory can be implemented within the processing unit or external to the processing unit. As used herein the term “memory” refers to any type of long term, short term, volatile, nonvolatile, or other storage devices and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media and/or other non-transitory media. A storage medium may be any available medium or device accessible by a computer. By way of example, and not limitation, such computer-readable storage mediums/media can comprise random access memory (RAM), read-only memory (ROM), electrically erasable programmable read-only memory (EEPROM), optical disk storage, magnetic disk storage or other magnetic storage devices, or any other medium that can be used to store desired program code in the form of instructions or data structures and that can be accessed or executed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, executable program instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The disclosure may be implemented in conjunction with various wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (I2 802.16) network and so on. A CDMA network may implement one or more radio access technologies (RATs) such as cdma2000, Wideband-CDMA (W-CDMA), and so on. Cdma2000 includes IS-95, IS2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an I2 802.11x network, and a WPAN may be a Bluetooth network, an I2 802.15x, or some other type of network. The techniques may also be implemented in conjunction with any combination of WWAN, WLAN and/or WPAN.

A mobile device or station may refer to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Designation that something is “optimized,” “required” or other designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations are possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. A method for performing object detection, the method comprising:
obtaining a reference dataset comprising a set of reference keyframes for an object captured in a plurality of different lighting environments;
capturing an image of the object in a current lighting environment;
grouping reference keyframes from the set of reference keyframes into respective subsets of reference keyframes according to one or more of: a reference keyframe camera position and orientation (pose), a reference keyframe lighting environment, or a combination thereof;
comparing, feature points of the image, with feature points of each of the reference keyframes in the set of reference keyframes;
selecting, in response to the comparing of the feature points of the image with feature points of the reference keyframes in the set of reference keyframes, a subset from the subsets of reference keyframes as a candidate subset of reference keyframes; and
selecting, for triangulation with the captured image of the object, feature points from a reference keyframe within the candidate subset of reference keyframes.

2. The method of claim 1, wherein the different lighting environments comprise one or more of: a lighting source position, a lighting intensity, a background configuration, or any combination thereof.

3. The method of claim 1, further comprising:
obtaining a lighting intensity value for the captured image;
obtaining a lighting intensity value for each of the reference keyframes in the set of reference keyframes;
determining, for each reference keyframe in the set of reference keyframes, an intensity difference between the lighting intensity value of the respective reference keyframe and the lighting intensity value for the captured image; and
excluding, from triangulation with the captured image, reference keyframes having a difference greater than a threshold.

4. The method of claim 3, wherein the lighting intensity value of the captured image is determined from one or more of:
a light sensor reading captured concurrently with the captured image,
a histogram for the captured image, or
any combination thereof.

5. The method of claim 1, wherein the comparing feature points further comprises:
determining, for each respective subset in the set of reference keyframes, a count of unique reference keyframes matching at least one feature point from the image; and
assigning the subset of reference keyframes with the greatest count of unique reference keyframes matching at least one feature point of the image as the candidate subset of reference keyframes.

6. The method of claim 1, wherein the comparing feature points further comprises:
determining, for each respective subset of reference keyframes, a total count of feature points in the respective subset of reference keyframes matching feature points from the captured image; and
assigning the respective subset of reference keyframes with the greatest total count of feature points matches as the candidate subset of reference keyframes.

7. The method of claim 1, wherein each of the respective subsets represents a pose region arranged in a representation of a geometric shape, wherein the geometric shape comprises the set of reference keyframes located at their respective poses.

8. The method of claim 1, wherein the comparing feature points further comprises:
determining a reference keyframe from the set of reference keyframes has a most number of feature point matches to feature points of the captured image;
determining the reference keyframe having the most number of feature point matches comprises a particular lighting environment; and
assigning the subset of reference keyframes representing the particular lighting environment as the selected candidate subset of reference keyframes.

9. A mobile device to perform object detection comprising:
a processor; and
a storage device coupled to the processor and configurable for storing instructions, which, when executed by the processor cause the processor to:
obtain a reference dataset comprising a set of reference keyframes for an object captured in a plurality of different lighting environments;
capture an image of the object in a current lighting environment;
group reference keyframes from the set of reference keyframes into respective subsets of reference keyframes according to one or more of: a reference keyframe camera position and orientation (pose), a reference keyframe lighting environment, or a combination thereof;
compare, feature points of the image, with feature points of each of the reference keyframes in the set of reference keyframes;
select, in response to the comparing of the feature points of the image with feature points of the reference keyframes in the set of reference keyframes, a subset from the subsets of reference keyframes as a candidate subset of reference keyframes; and
select, for triangulation with the captured image of the object, feature points from a reference keyframe within the candidate subset of reference keyframes.

10. The mobile device of claim 9, wherein the different lighting environments comprise one or more of: a lighting source position, a lighting source intensity, a background configuration, or any combination thereof.

11. The mobile device of claim 9, further comprising instructions to:
obtain a lighting intensity value for the captured image;
obtain a lighting intensity value for each of the reference keyframes in the set of reference keyframes;
determine, for each reference keyframe in the set of reference keyframes, an intensity difference between the lighting intensity value of the respective reference keyframe and the lighting intensity value for the captured image; and
exclude, from triangulation with the captured image, reference keyframes having a difference greater than a threshold.

12. The mobile device of claim 11, wherein the lighting intensity value is determined from one or more of:
a light sensor reading captured concurrently with the captured image,
a histogram for the captured image, or
any combination thereof.

13. The mobile device of claim 9, wherein the comparing feature points further comprises instructions to:
determine, for each respective subset, a count of unique reference keyframes matching at least one feature point from the image; and
assign the subset with the greatest count of unique reference keyframes matching at least one feature point of the image as the candidate subset of reference keyframes.

14. The mobile device of claim 9, wherein the comparing feature points further comprises:
determine, for each respective subset, a total count of the feature points in the respective subset that match feature points from the image; and
assign the respective subset with the greatest total count of feature points matches as the candidate subset of reference keyframes.

15. The mobile device of claim 9, wherein each of the respective subsets represents a pose region arranged in a representation of a geometric shape, wherein the geometric shape comprises the set of reference keyframes located at their respective poses.

16. The mobile device of claim 9, wherein the comparing feature points further comprises:
determine a reference keyframe with a most number of feature point matches to the image feature points;
determine the reference keyframe with the most number of feature point matches comprises a particular lighting environment;
assign the subset representing the particular lighting environment as the selected candidate subset of reference keyframes.

17. A machine readable non-transitory storage medium containing executable program instructions which cause a mobile device to perform a method for object detection, the method comprising:
obtaining a reference dataset comprising a set of reference keyframes for an object captured in a plurality of different lighting environments;
capturing an image of the object in a current lighting environment;
grouping reference keyframes from the set of reference keyframes into respective subsets of reference keyframes according to one or more of: a reference keyframe camera position and orientation (pose), a reference keyframe lighting environment, or a combination thereof;
comparing, feature points of the image, with feature points of each of the reference keyframes in the set of reference keyframes;
selecting, in response to the comparing of the feature points of the image with feature points of the reference keyframes in the set of reference keyframes, a subset from the subsets of reference keyframes as a candidate subset of reference keyframes; and
selecting, for triangulation with the captured image of the object, feature points from a reference keyframe within the candidate subset of reference keyframes.

18. The medium of claim 17, wherein the different lighting environments comprise one or more of: a lighting source position, a lighting source intensity, a background configuration, or any combination thereof.

19. The medium of claim 17, further comprising:
obtaining a lighting intensity value for the captured image;
obtaining a lighting intensity value for each of the reference keyframes in the set of reference keyframes;
determining, for each reference keyframe in the set of reference keyframes, an intensity difference between the lighting intensity value of the respective reference keyframe and the lighting intensity value for the captured image; and
excluding, from triangulation with the captured image, reference keyframes having a difference greater than a threshold.

20. The medium of claim 19, wherein the lighting intensity value is determined from one or more of:
a light sensor reading captured concurrently with the captured image,
a histogram for the captured image, or
any combination thereof.

21. The medium of claim 17, wherein the comparing feature points further comprises:
determining, for each respective subset, a count of unique reference keyframes matching at least one feature point from the image; and
assigning the subset with the greatest count of unique reference keyframes matching at least one feature point of the image as the candidate subset of reference keyframes.

22. The medium of claim 17, wherein the comparing feature points further comprises:
determining, for each respective subset, a total count of the feature points in the respective subset that match feature points from the image; and
assigning the respective subset with the greatest total count of feature points matches as the candidate subset of reference keyframes.

23. The medium of claim 17, wherein the comparing feature points further comprises:
determining a reference keyframe with a most number of feature point matches to the image feature points;
determining the reference keyframe with the most number of feature point matches comprises a particular lighting environment;
assigning the subset representing the particular lighting environment as the selected candidate subset of reference keyframes.

24. An apparatus to perform object detection, the apparatus comprising:
means for obtaining a reference dataset comprising a set of reference keyframes for an object captured in a plurality of different lighting environments;
means for capturing an image of the object in a current lighting environment;
means for grouping reference keyframes from the set of reference keyframes into respective subsets of reference keyframes according to one or more of: a reference keyframe camera position and orientation (pose), a reference keyframe lighting environment, or a combination thereof;
means for, feature points of the image, with feature points of each of the reference keyframes in the set of reference keyframes;
means for selecting, in response to the comparing of the feature points of the image with feature points of the reference keyframes in the set of reference keyframes, a subset from the subsets of reference keyframes as a candidate subset of reference keyframes; and
means for selecting, for triangulation with the captured image of the object, feature points from a reference keyframe within the candidate subset of reference keyframes.

25. The apparatus of claim 24, wherein the different lighting environments comprise one or more of: a lighting source position, a lighting source intensity, a background configuration, or any combination thereof.

26. The apparatus of claim 24, further comprising:
means for obtaining a lighting intensity value for the captured image;
means for obtaining a lighting intensity value for each of the reference keyframes in the set of reference keyframes;
means for determining, for each reference keyframe in the set of reference keyframes, an intensity difference between the lighting intensity value of the respective reference keyframe and the lighting intensity value for the captured image; and
means for excluding, from triangulation with the captured image, reference keyframes having a difference greater than a threshold.

27. The apparatus of claim 26, wherein the lighting intensity value is determined from one or more of:
a light sensor reading captured concurrently with the captured image,
a histogram for the captured image, or
any combination thereof.

28. The apparatus of claim 24, wherein the comparing feature points further comprises:
means for determining, for each respective subset, a count of unique reference keyframes matching at least one feature point from the image; and
means for assigning the subset with the greatest count of unique reference keyframes matching at least one feature point of the image as the candidate subset of reference keyframes.

29. The apparatus of claim 24, wherein the comparing feature points further comprises:
means for determining, for each respective subset, a total count of the feature points in the respective subset that match feature points from the image; and
means for assigning the respective subset with the greatest total count of feature points matches as the candidate subset of reference keyframes.

30. The apparatus of claim 24, wherein the comparing feature points further comprises:
means for determining a reference keyframe with a most number of feature point matches to the image feature points;
means for determining the reference keyframe with the most number of feature point matches comprises a particular lighting environment;
means for assigning the subset representing the particular lighting environment as the selected candidate subset of reference keyframes.
